(19) United States
(12) Patent Application Publication
(10) Pub. No.: US 2026/0227586 A1
(43) Pub. Date: Aug. 6, 2026

(54) PLUGGABLE OPTICAL PROTECTION SWITCH

(71) Applicant: II-VI PHOTONICS, INC., Fujian (CN)

(72) Inventors: Xiangfei Wang, Fujian (CN); Shuai Wang, Fujian (CN); Youxun Cai, Fujian (CN); Jun Han, Fujian (CN); Wenjing Yan, Fujian (CN)

(21) Appl. No.: 19/159,810

(22) PCT Filed: May 25, 2023
(86) PCT No.: PCT/CN2023/096357

§ 371 Date: Aug. 26, 2025

(51) Int. Cl. G02B 6/42; G02B 6/26; G02B 6/35

(52) U.S. Cl. CPC G02B 6/4261; G02B 6/266; G02B 6/355; G02B 6/3582; G02B 6/4286

(57) ABSTRACT

A pluggable optical protection switch (OPS, 103) is able to select between two fiber lines (109, 111) wherein a selected fiber line is an active fiber line and an unselected fiber line is a redundant standby fiber line. The pluggable OPS may be designed in a Quad Small Factor Pluggable (QSFP) form factor, such as a QSFP-DD form factor or a QSFP28 form factor.

### BACKGROUND

Limitations and disadvantages of traditional optical protection switches will become apparent to one of skill in the art, through comparison of such approaches with some aspects of the present method and system set forth in the remainder of this disclosure with reference to the drawings.

### BRIEF SUMMARY

Systems and methods are provided for pluggable optical protection switches, substantially as illustrated by and/or described in connection with at least one of the figures, as set forth more completely in the claims.

### BRIEF DESCRIPTION OF THE DRAWINGS

FIG. 1 illustrates an example of a pluggable optical protection switch in accordance with various example implementations of this disclosure.

FIGS. 2A and 2B illustrate examples of switch covers for a pluggable optical protection switch in accordance with various example implementations of this disclosure.

FIG. 3 illustrates an example fiber clip for a pluggable optical protection switch in accordance with various example implementations of this disclosure.

FIGS. 4A, 4B and 4C illustrate additional examples of fiber clips for a pluggable optical protection switch in accordance with various example implementations of this disclosure.

FIGS. 5A and 5B illustrate examples of pluggable optical protection switch circuits in accordance with various example implementations of this disclosure.

FIGS. 6A and 6B illustrate an example form factor for a pluggable optical protection switch circuit in accordance with various example implementations of this disclosure.

FIG. 7 illustrates examples of optical paths in a pluggable optical protection switch circuit in accordance with various example implementations of this disclosure.

FIG. 8 illustrates another example form factor for a pluggable optical protection switch circuit in accordance with various example implementations of this disclosure.

FIG. 9 illustrates another example of a pluggable optical protection switch circuit in accordance with various example implementations of this disclosure.

FIG. 10 illustrates an example of a controller for a pluggable optical protection switch circuit in accordance with various example implementations of this disclosure.

### DETAILED DESCRIPTION

An optical protection switch (OPS) is typically a rack-mounted device for monitoring multi-channel optical fiber networks.

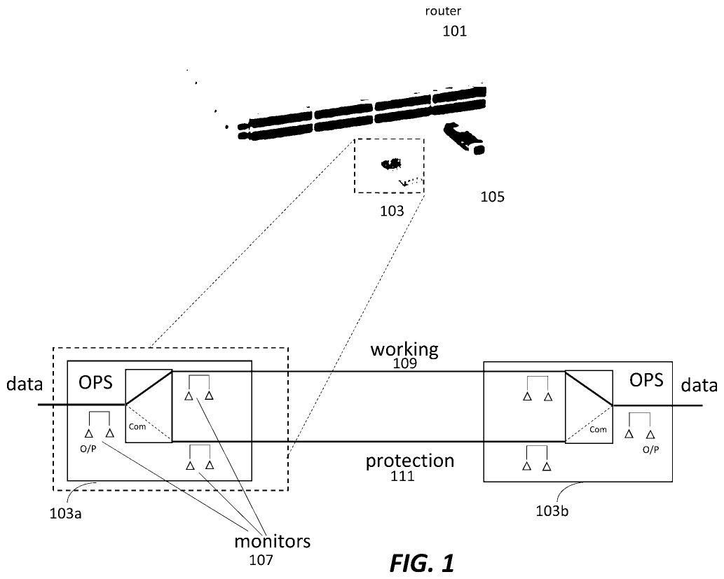

FIG. 1 illustrates an example of a pluggable OPS 103 in accordance with various example implementations of this disclosure. As illustrated, an OPS 103 is pluggable into a rack-mounted device, such as a router 101. Other devices, such as a transceiver 105, may also be plugged into the router 101.

Optical networks may use two fibers 109 and 111 for a link from one OPS 103a to another OPS 103b. One fiber 109 may carry live traffic, while the other fiber 111 is a back-up in case the live fiber 109 is determined to be damaged according to optical power monitors 107. Thus, the OPS's 103a and 103b are able to automatically select the fiber to use. Data may be sent in one direction or in both directions down the active fiber 109. The OPS 103a and 103b may comprise a latching or non-latching switch. A latching switch will maintain a particular state if there is a power outage.

The pluggable OPS 103 may be a small form-factor pluggable (SFP) device. Example dimensions of standardized SFP's include OSFP (Octal Small Form Factor Pluggable), QSFP-DD (quad small form factor pluggable-double density) and QSFP28 (quad small form factor pluggable with 28G data rate per lane).

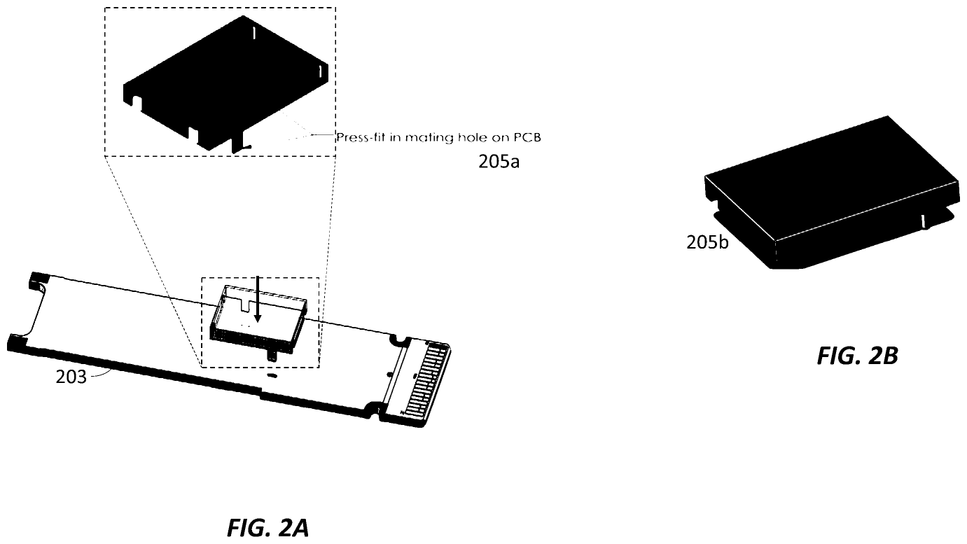

FIG. 2A illustrates an example metal switch cover and housing 205a for a pluggable OPS 103 in accordance with various example implementations of this disclosure. One benefit of a metal cover and housing 205a is that the thickness may be thinner than plastic. For example, a metal switch cover and housing 205a may be 0.2 mm. The material of metal switch cover and housing 205a may be SUS300 series stainless steel. The metal switch cover and housing 205a may comprise tabs that can be mounted via slits in the PCB 203.

FIG. 2B illustrates an example plastic switch cover and housing 205b for a pluggable OPS 103 in accordance with various example implementations of this disclosure. The plastic cover and housing 205b (like the metal cover and housing 205a) is configured to protect an unpackaged, bare switch and be tough enough to support the components above it, while maintaining reliability and protecting from moisture, heat and dust. The plastic cover and housing 205b may be an injection-molded part with two small guide pillars. The plastic cover and housing 205b may be mounted by two guide pillars. The two masts may be mounted at opposite angles. The plastic cover and housing 205b may be mounted into a PCB 203 by the two masts. The plastic cover and housing 205b may have a thickness of 0.6 mm. The optical fibers throughout may be protected by a heat shrink tube and may be bonded to the plastic cover and housing 205b with a glue or epoxy. The plastic cover and housing 205b may comprise glass fiber reinforced high performance engineering thermoplastic polymer, such as ULTEM 2300 OR 2310 (e.g., 100% VIRGIN, 30% GF). The plastic cover and housing 205b (like the metal cover and housing 205a) may form a quasi-hermetic package, for example, comprising epoxy around the base of the plastic or metal housing 205, either directly to PCB 203 or to a base that attaches to PCB 203.

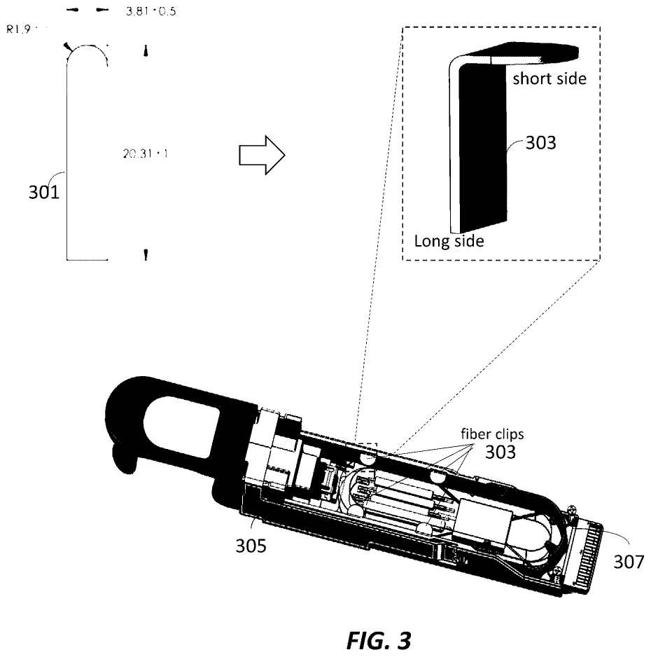

FIG. 3 illustrates an example fiber clip 303 for a pluggable OPS 103 in accordance with various example implementations of this disclosure. The fiber clip 303 is used to manage fiber, e.g., in combination with a compact Erbium-Doped Fiber Amplifier (EDFA). The fiber clip 103 may consist of 4 thin layers and total thickness is 0.38 mm. Layer 1 may comprise a pressure sensitive adhesive (PSA) that allows the fiber clip 103 to be pasted in any desired location. Layer 2 may comprise an overlay to protect the optical fibers that may come in contact with the fiber clip 103. Layer 3 may comprise an aluminum foil to provide a flexible support for the optical fibers. Layer 4 may comprise a second overlay to protect the optical fibers. The fiber clip 303 may be formed from a flat material by cutting and bending the material to the desired shape according to the fixture 305 and PCB 307. The fiber clip 303 may be made of a soft material.

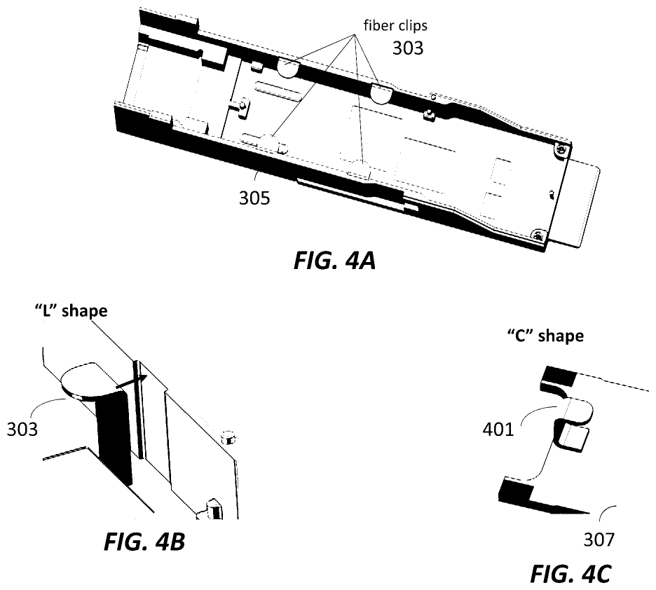

FIG. 4A illustrates an additional example of fiber clips 303 for a pluggable OPS 103 in accordance with various example implementations of this disclosure. The fiber clip 303 may be bent to an “L” shape before being glued on a wall of the housing 305. The long side of “L” shape fiber clip 303 may be affixed onto housing 305. The length of the long side of “L” shape fiber clip 303 may be at least 4 mm, such that the fiber clip 303 may be adhered tightly to the housing 305. The short side of fiber clip 303 is configured to maintain all of the fibers in place. The length of the short side of fiber clip 303 is dependent on the total length of all fibers, e.g., at least 2.5 mm.

As shown in FIG. 4B, grooves may be designed on housing 305 to mount the “L” shaped fiber clip 303, such that the fiber clip 303 does not contact the PCB.

As shown in FIG. 4C, another fiber clip 401 may be bent to a “C” shape and surface soldered on a PCB 307.

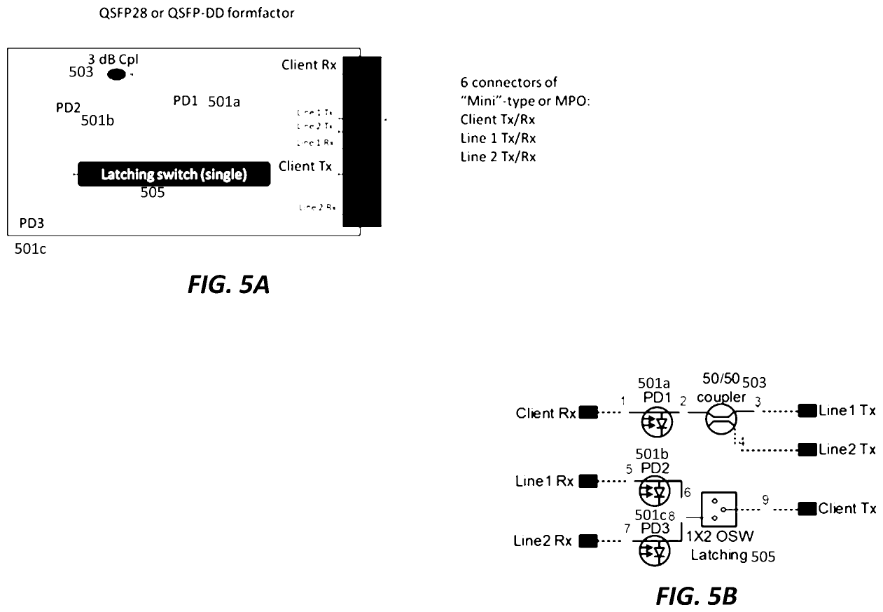

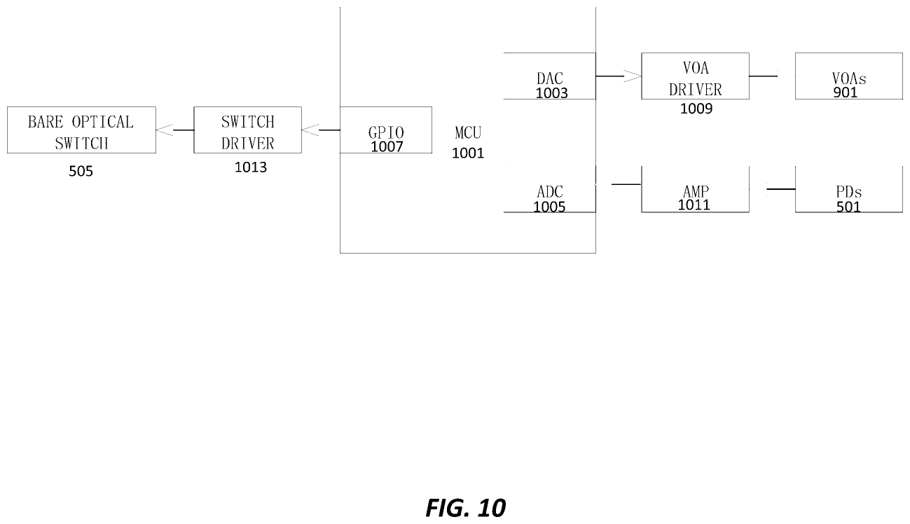

FIGS. 5A and 5B illustrate examples of pluggable OPS 103 circuit in accordance with various example implementations of this disclosure. The circuit illustrated in FIGS. 5A and 5B may comprise a latching OPS for mounting in a compact QSFP28 or QSFP-DD form factor with at least a coupler 503, an optical switch 505, three PDs 501a, 501b and 501c and a controller circuitry as described in more detail below with respect to FIG. 10.

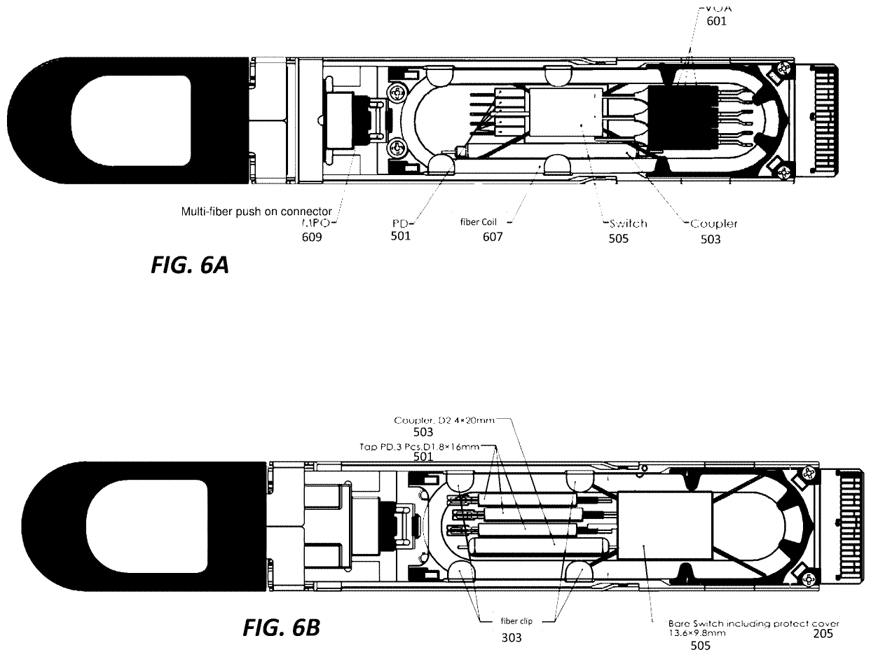

FIGS. 6A and 6B illustrate an example form factor for a pluggable OPS 103 circuit in accordance with various example implementations of this disclosure. FIGS. 6A and 6B illustrate a latching OPS in a compact QSFP-DD form factor with at least a coupler 503, an optical switch 505, three photo diodes (PDs) 501 and controller circuitry. The optical interface 609 may be, for example, a multi-fiber push on (MPO) connector, an SN connector or a mini duplex connector (MDC). An alternative optical interface may support 6 fibers in a QSFP format and may comprise a standard optical interface, e.g., 3 Dual SN optical port, 3 Dual MDC optical port or MPO optical port. Components (e.g., variable optical attenuators (VOA) and fiber coil 607) may be mounted around the switch 505. The QSFP-DD form factor complies with QSFP-DD multi-service agreement (MSA).

The QSFP-DD package may comprise or consist of a housing, cover, latch, spring and fastening screw. A bare switch 505 may be used to fit into the form factor. A thin sheet metal cover 205 may be used to protect the bare switch 505. Other optical components may be stacked above the switch's protection cover in the QSFP form factor. A heat shrink tube may be used at the joint of the OPS 103 case and the fiber outlet position to protect the fiber and relief stress.

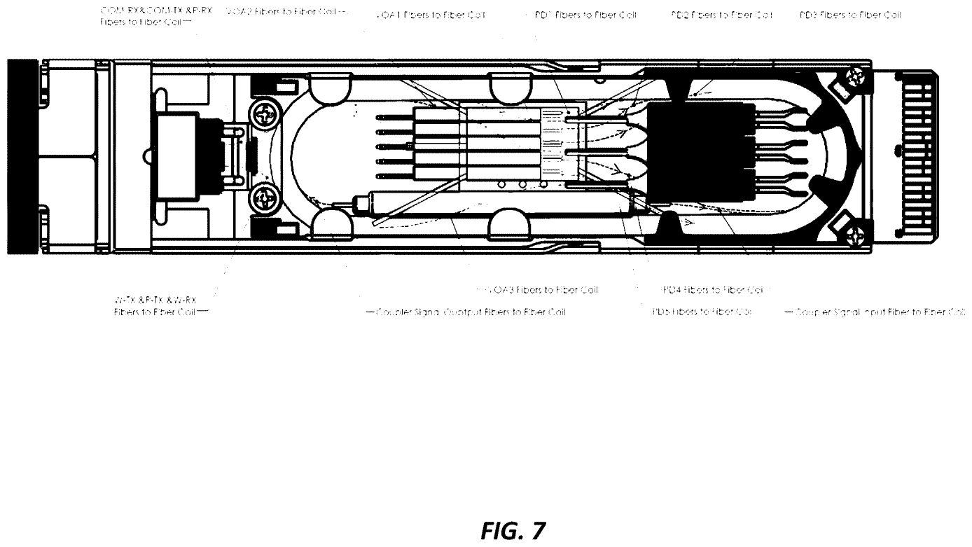

FIG. 7 illustrates examples of optical paths (i.e., fiber routes) in a pluggable OPS 103 circuit in accordance with various example implementations of this disclosure. Each fiber length should be about 0.4 m to splice and provide the fiber exit direction as illustrated. All fibers are stored in fiber coil area. The illustrated fiber routes include: com-Rx/com-Tx/p-Rx fibers to fiber coil, w-Rx/w-Tx/p-Tx fibers to fiber coil, VOA 1 to fiber coil, VOA 2 to fiber coil, VOA 3 to fiber coil, PD 1 to fiber coil, PD 2 to fiber coil, PD 3 to fiber coil, PD 4 to fiber coil, PD 5 to fiber coil, and coupler signal input fiber to fiber coil, coupler signal output fibers to fiber coil.

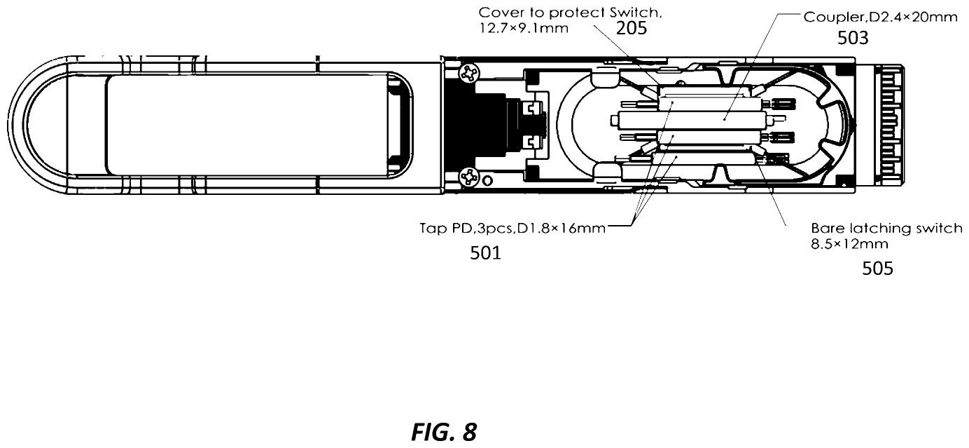

FIG. 8 illustrates another example form factor for a pluggable OPS 103 circuit in accordance with various example implementations of this disclosure. FIG. 8 illustrates an OPS 103 in a QSFP28 form factor. The OPS 103 in FIG. 8 illustrates the placement of a switch 505, a switch cover 205, a coupler 503, and 3 PDs 501.

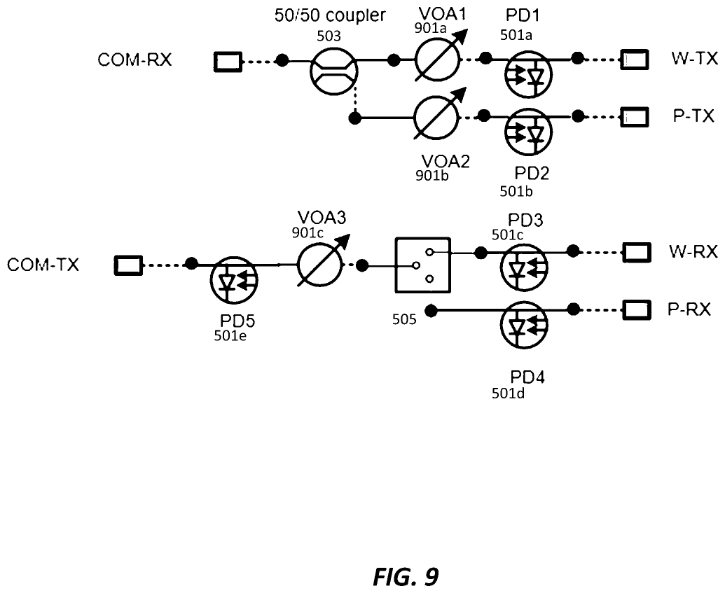

FIG. 9 illustrates another example of a pluggable OPS 103 circuit in accordance with various example implementations of this disclosure. The circuit of FIG. 9 comprises a coupler 503, an optical switch 505, five PDs 501a-e, three VOAs 901a-c and controller circuitry as described in further detail below with respect to FIG. 10.

FIG. 10 illustrates an example of a controller for a pluggable OPS 103 circuit in accordance with various example implementations of this disclosure. The microcontroller unit (MCU) 1001 is configured to control the attenuation of a VOA 901 via a DAC 1003 and a VOA driver 1009. The MCU 1001 is configured to monitor the optical power of the PDs 501 via an ADC 1005 and amp 1011. According to the power of the PDs 501, the MCU 1001 is configured to toggle the switch 505 via a GPIO 1007 and switch driver 1013.

As used herein the terms “fiber” and “fibre” are interchangeable. As used herein the terms “PCB”, “PCA” and “PCBA” are used interchangeably to mean a printed circuit board, printed circuit assembly and/or a printed circuit board assembly. As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As used herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, the term “based on” means “based at least in part on.” For example, “x based on y” means that “x” is based at least in part on “y” (and may also be based on z, for example).

What is claimed is:

1. A system, comprising:
a small form-factor pluggable (SFP) device comprising:
a switch operable to select between two fiber lines, wherein a selected fiber line is an active fiber line and an unselected fiber line is a redundant standby fiber line;
a monitor operable to determine an optical power inside the active fiber line; and
a controller operable to control the switch according to the optical power inside the active fiber line.

2. The system of claim 1, wherein the switch is a latching switch.

3. The system of claim 1, wherein the switch is a non-latching switch.

4. The system of claim 1, wherein the SFP device comprises one or more couplers.

5. The system of claim 1, wherein the SFP device comprises one or more optical switches.

6. The system of claim 1, wherein the SFP device comprises one or more photodiodes.

7. The system of claim 1, wherein the SFP device comprises one or more variable optical attenuators.

8. The system of claim 1, wherein the SFP device comprises one or more controller circuits.

9. The system of claim 1, wherein the SFP device comprises one or more bare switches.

10. The system of claim 1, wherein the switch comprises a metal cover.

11. The system of claim 1, wherein the switch is housed in a metal package.

12. The system of claim 1, wherein the switch comprises a plastic cover.

13. The system of claim 1, wherein the switch is housed in a plastic package.

14. The system of claim 1, wherein one or more components in the SFP device are located on top of the switch.

15. The system of claim 1, wherein one or more components in the SFP device are located around the switch.
